(19) United States
(12) Patent Application Publication
(10) Pub. No.: US 2012/0135115 A1
(43) Pub. Date: May 31, 2012

(54) Method for Preparation of Hard Foods for Consumption

(76) Inventor: Floyd Leroy Wilson, Manhattan, KS (US)

(21) Appl. No.: 12/956,032

(22) Filed: Nov. 30, 2010

(51) Int. Cl. A23L 1/025

(52) U.S. Cl. 426/238

(57) ABSTRACT

A method for preparation of a hard food for consumption, the method including performance of steps of providing a vessel having an interior space; partially filling the vessel's interior space with water; further filling the vessel's interior space with the hard food; absorbing a portion of the water into the hard food during a soaking time to form a water and food media; providing an ultrasonic transducer and operatively associating the ultrasonic transducer with the vessel's interior space; providing an ultrasound generator and operatively connecting the ultrasound generator with the ultrasonic transducer; and operating the ultrasound generator and the ultrasonic transducer to drive multiplicities of cavitating waves through the water and food media.

### FIELD OF THE INVENTION

This invention relates to non-heated procedures and processes for preparing hard foods such as beans, peas, rice, corn, nuts, and grain kernels for human consumption. More particularly, this invention relates to such processes and methods which utilize high intensity ultrasound waves to break fibrous matrices within and soften such hard foods.

### BACKGROUND OF THE INVENTION

Many hard foods such as hard dry beans, dry peas, hard dry rice, hard dry corn, nuts, and grain kernels are unfit for human consumption until after their compact and hardened forms and their fibrous contents are softened, making them suitable for mastication and digestion. A commonly known and utilized means for softening such food items includes immersion of the food items within water within a vessel, and boiling the food items therein for a period of time. However, such boiling hard foods preparation method often undesirably degrades or dissipates the vitamin and other nutrients' content of the food item, and such boiling method often results in an overcooked or over softened state of food item exteriors prior to the occurrence of an adequately cooked or softened character within the food item's interior.

The instant inventive method solves or ameliorates the problems and deficiencies discussed above by providing and executing novel and unique method steps and step combinations which soften the food items by exposing the food items to cavitating ultrasonic sound waves.

### BRIEF SUMMARY OF THE INVENTION

A first step of the instant inventive method for preparation of hard foods for consumption includes providing a vessel having an interior space. In a typical and preferred performance of the instant inventive method, such vessel comprises an open topped vat, pot, or kettle having an interior between five and ten gallons. Preferably, the vessel providing step includes provision of an upper flange or lip for attachment of ultrasound transducer equipment, as is further discussed below.

In a further step of the instant inventive method, the provided vessel is partially filled with water which advantageously functions as a media for transmission of cavitating ultrasonic waves. In a further step of the instant inventive method, the interior of the space of the kettle is further filled with hard food items such as hard beans, dried peas, hard rice, hard corn, nuts, or grain kernels.

In a further step of the instant inventive method, a portion of the water within the vessel is absorbed into the hard food items during a soaking time. In a preferred embodiment, the soaking time is between one and ten hours depending upon the absorbent character of the hard food to which the method is applied.

In a further preferred step of the instant inventive method, an ultrasonic transducer is provided, such transducer being operatively associated with the vessel's interior space, within the water within the vessel, and among and surrounded by the water absorbed hard food items within the vessel. In a preferred embodiment, the ultrasonic transducer comprises a piezoelectric transducer. Alternatively, the ultrasonic transducer may comprise a magnetostrictive transducer. Where the preferred piezoelectric transducer is provided, it is preferably operated at least 40,000 hertz for reduction of undesirable sub-harmonics noise occurring within sound frequencies audible to humans.

In a further step of the instant inventive method, an ultrasound generator is provided, such generator being operatively electrically connected to the transducer for driving the transducer and for generating ultrasonic sound waves within the water and food items media. Preferably, the ultrasound generator drives the transducer at a power level sufficient for producing food softening cavitation within the media. In a preferred embodiment, the ultrasonic cavitation of the food items occurs during a time period selected between ten minutes and fifty minutes. Preferably, timer switches operatively incorporated within the ultrasound generator provide for selectable and automatic food item soaking times and selectable and automatic food item ultrasonic cavitation times.

In further steps of the instant inventive method, the ultrasound cavitated food items are extracted and withdrawn from the water media, and such food items are placed upon drying trays. Preferably, a commercial food drying case is provided for performance of such drying step.

Upon completion of drying of the ultrasound softened food items, such food items are advantageously rendered suitable for human consumption. Where remoistening of the food items is desired, they may be easily and economically reimmersed within heated water and may be heated for human consumption or for incorporation within other food preparations.

Accordingly, objects of the instant invention include the provision of and performance of a method for preparation of hard foods for human consumption which incorporate the method steps described above, and which associate such steps with each other in manners described above.

Other and further objects, benefits, and advantages of the instant inventive method will become known to those skilled in the art upon review of the Detailed Description which follows, and upon review of the appended drawings.

### BRIEF DESCRIPTION OF THE DRAWINGS

FIG. 1 depicts structure associated with vessel providing and vessel filling steps of the instant inventive method.

FIG. 2 redepicts the structure of FIG. 1, the view of FIG. 2 further representing a further vessel filling step and a water absorbing step of the instant inventive method.

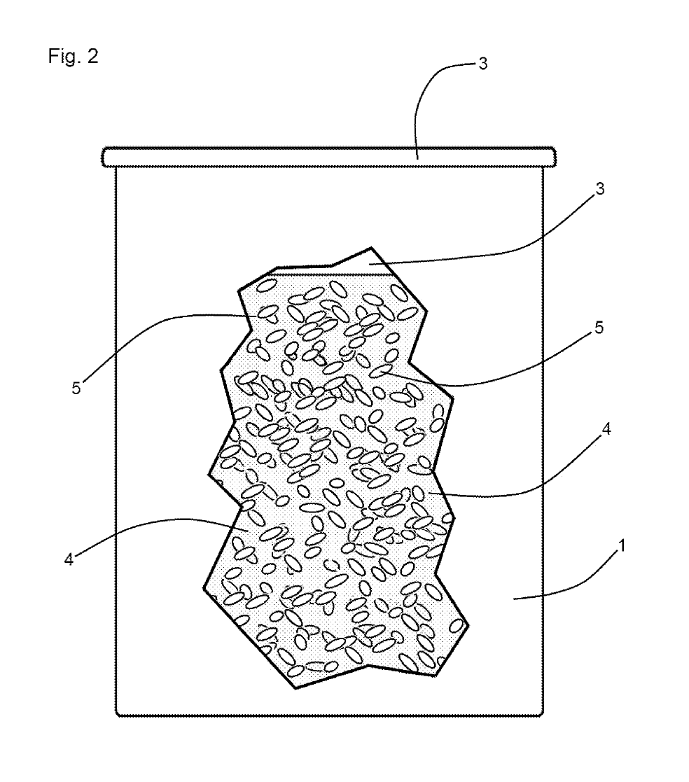

FIG. 3 redepicts the structures of FIGS. 1 and 2, the view of FIG. 3 further depicting structure associated with ultrasonic transducer and ultrasound generator providing steps of the instant inventive method.

FIG. 4 redepicts the structure of FIG. 3, the view showing structures assembled and representing food soaking and ultrasonic cavitating steps of the instant inventive method.

FIG. 5 depicts structure associated with food drying steps of the instant inventive method.

### DETAILED DESCRIPTION OF PREFERRED MODE OF PERFORMANCE OF METHOD

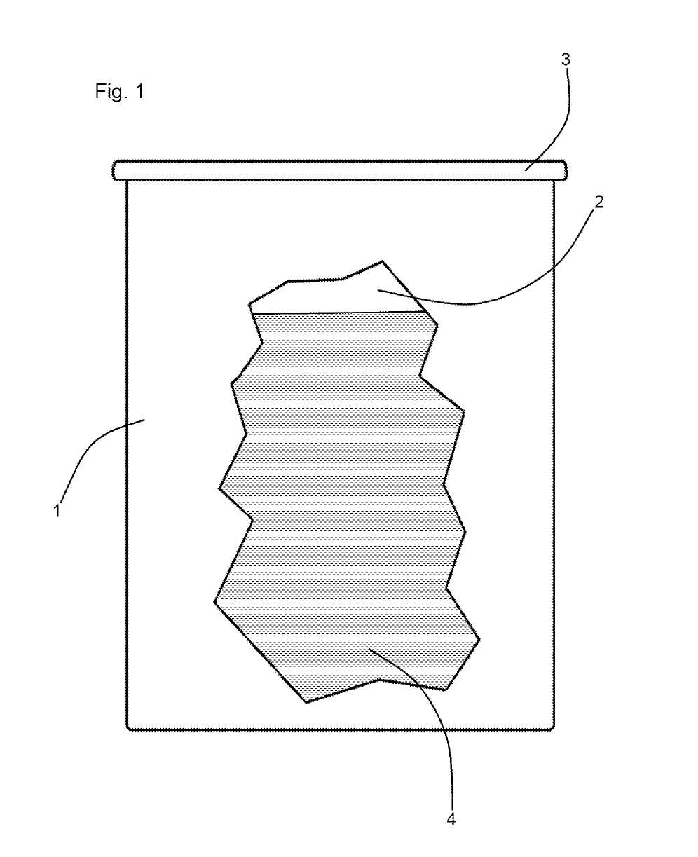

Referring now to the drawings, and in particular to FIG. 1, a preferred mode of performance of the instant inventive method for preparation of hard foods for consumption includes providing a vessel 1, the vessel 1 preferably forming and defining and upwardly opening interior space 2. In a preferred performance of the method, the provided vessel 1 constitutes a kettle, pot, or vat having a capacity between five and ten gallons. Such vessel preferably presents a flanged lip 3 at its open upper end, and is preferably composed of stainless steel or aluminum.

In further steps of the instant inventive method, the interior space 2 of the vessel 1 is partially filled with water 4, and the interior 2 of the vessel 1 is further filled with a granulate or particulate hard food items 5. The structures denoted by Reference Numeral 5 are representative of food item providing steps wherein hard beans, dried peas, dry hard rice, dry hard corn, nuts, or hard grain kernels are introduced into the interior 2 and immersed within the water 4. Upon such food item introduction, a soaking or water absorption step is preferably performed wherein portions of the water 4 are absorbed into the interiors of food items 5. In preferred performances of the method, soaking/absorption times between one hour and ten hours are executed, the soaking/absorption time being dependent upon the particular absorbent character of the selected hard food item.

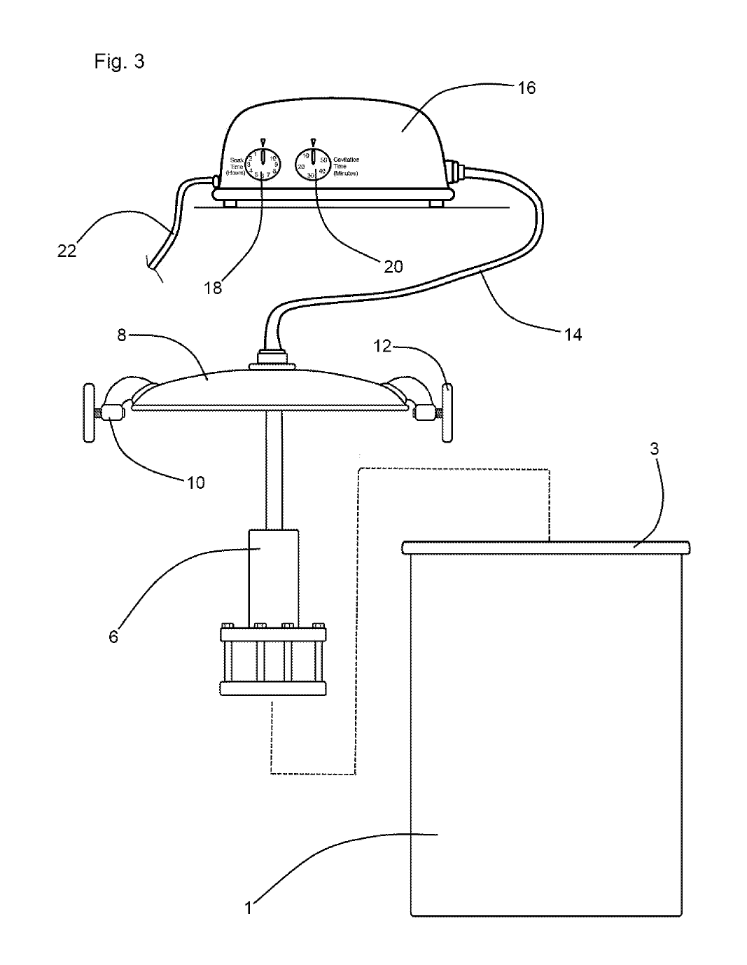

Referring to Drawing FIG. 3, the structure denoted by reference numeral 6 is representative of a preferred ultrasonic transducer providing step of the instant inventive method. In a preferred performance of the method, the provided transducer 6 constitutes a piezoelectric transducer which operates at a frequency of approximately 40,000 hertz. Suitably, the ultrasonic transducer 6 may comprise a magnetostrictive transducer. However, such magnetostrictive transducers are relatively less desirable as they typically operate at lower frequencies and produce sub-harmonic or half harmonic tones below 20,000 hertz within the audible hearing range of humans. Such sub-harmonic tones may be excessively loud, making utilization of piezoelectric transducers more desirable.

FIG. 3 is further representative of a method step of providing an ultrasound generator 16, such generator 16 having an electrical power input cord 22, and such generator 16 being electrically operatively connected to the transducer 6 by electric pulse transmission cable 14.

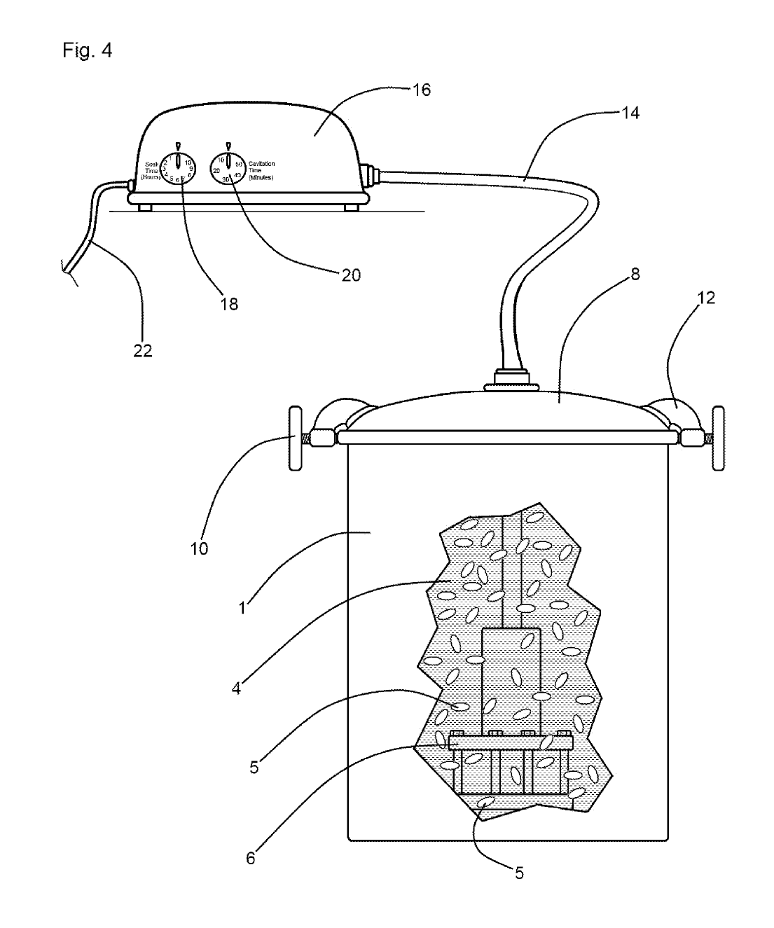

Referring simultaneously to FIGS. 3 and 4, a preferred step of operatively associating the transducer 6 with the interior of the vessel 1, and of immersing at least the vibrating distal end of the transducer 6 within the water 4 and hard foods media 5 is represented. A lid 8 is preferably associated with the transducer 6, such lid 8 dually functioning for covering the upper opening of the vessel 3 and for centrally positioning and suspending the transducer 6 within the interior of the vessel 1. In a preferred embodiment, clamp brackets 10 and 12 are provided for securely and releasably holding the lid 8 and its suspended transducer 6 upon and within the vessel 1.

Referring to FIG. 4, in a preferred mode of performance of the instant inventive method, the hard food items 5 are, as discussed above, allowed to soak within the water 4 and to partially absorb the water 4 during the soaking time step which extends between one and ten hours depending upon the absorbent character of the selected food item 5. Upon completion of a properly selected water absorbing time, the food items 5 and the partially absorbed water 4 advantageously constitutes and are together transformed into a water and food media, such media being suitable for transmission of ultrasound waves.

Referring further to FIG. 4, in the preferred performance of the instant inventive method, the ultrasound transmission results from a cavitating step wherein the ultrasound generator 16 and the ultrasonic transducer 6 are actuated and operated to drive multiplicities of fluid and semi-solid material cavitating ultrasonic sound waves through the water and food item media 4,5. Such cavitating wave driving step advantageously propels the multiplicities of cavitating waves through the semi-solid food items 5 to create and establish multiplicities of structural cavitation gaps within such food items' interiors. Such interior cavitating wave induced gaps within the food items 5 constitute micro-fissures within the internal fibrous matrices of the food items 5, such micro-fissures advantageously permanently softening the food items 5. In a preferred performance of the method, the ultrasonic wave induced food item cavitation step is performed for a time period between ten minutes and fifty minutes. Upon completion of such food item cavitating step, the food items are advantageously rendered amenable to mastication and digestion without the requirement of any heated cooking step.

Referring to FIG. 4, the ultrasound generator providing step preferably incorporates a soaking time timer 18 and a ultrasonic cavitation time timer 20, such timers being operatively adapted for automatically starting the cavitation step after completion of a preset soaking time between one and ten hours, and for automatically terminating the successively started cavitation step after completion of a preset cavitation time between ten minutes and fifty minutes.

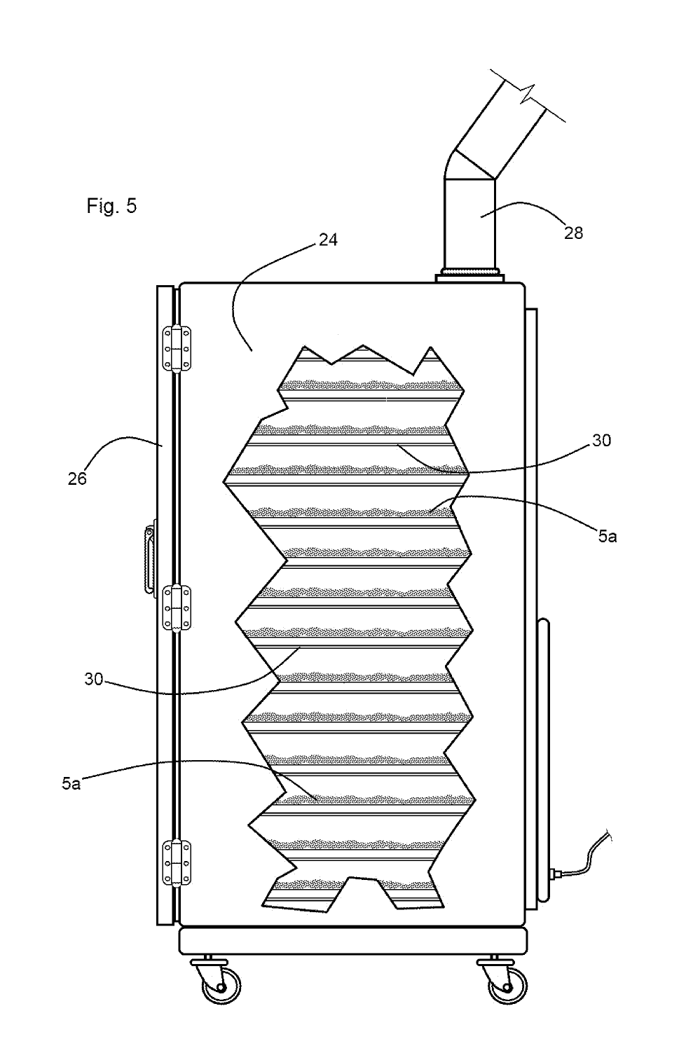

Referring simultaneously to FIGS. 3, 4, and 5, after completion of the ultrasonic wave induced food item cavitation step, clamps 10 and 12 may be loosened and the lid 8 and transducer 6 may be lifted upwardly away from and out of the vessel 1. Thereafter, the water 4 and food items 5 media may be poured into and strained by a colander (not depicted within views) for separating free water from the cavitation softened food items 5. Thereafter, according to a preferred performance of the instant method, the colander strained food items 5 may be disposed over trays 30 for drying, the cavitation softened and wet food items 5 being gradually transformed into dried and cavitation softened food items 5a. In a preferred performance of the instant inventive method, a plurality of such drying trays 30 are provided, such trays being inserted into and received for drying within a commercial dryer case 24, such case 24 having a door 26 and exhaust vent 28.

The instant inventive method advantageously processes the food items 5 for mastication and human digestion without the requirement of any heated cooking method step, and without the undesirable degrading effect of such heat upon vitamins and minerals within the food items 5.

While the principles of the inventive method have been made clear in the above illustrative embodiment, those skilled in the art may make modifications to or substitutions for the method steps of the invention without departing from those principles. Accordingly, it is intended that the description and drawings be interpreted as illustrative and not in the limiting sense, and that the inventive method be given a scope commensurate with the appended claims.

I claim:

1. A method for preparation of a hard food for consumption, the method comprising steps of:
(a) providing a vessel having an interior space;
(b) partially filling the vessel's interior space with water;
(c) further filling the vessel's interior space with the hard food;
(d) absorbing a portion of the water into the hard food during a soaking time to form a water and food media;
(e) providing an ultrasonic transducer and operatively associating the ultrasonic transducer with the vessel's interior space;
(f) providing an ultrasound generator and operatively connecting the ultrasound generator with the ultrasonic transducer; and
(g) operating the ultrasound generator and the ultrasonic transducer to drive multiplicities of cavitating waves through the water and food media.

2. The method of claim 1 further comprising steps of extracting the water and food media from the vessel, placing said media's food upon at least a first drying tray, and drying said media's food thereon.

3. The method of claim 2 wherein the hard food preparation includes provision of a food item selected from the group consisting of beans, peas, rice, corn, nuts, and grain kernels.

4. The method of claim 3 wherein the vessel providing step includes provision of an open topped kettle.

5. The method of claim 4 wherein the absorbing step is executed for a time period between one and ten hours.

6. The method of claim 5 wherein the ultrasonic transducer providing step includes a provision of either a piezoelectric transducer or a magnetostrictive transducer.

7. The method of claim 6 wherein the ultrasonic transducer providing step immerses at least a portion of the provided piezoelectric transducer or a magnetostrictive transducer within the water and food media.

8. The met hod of claim 7 wherein the operating the ultrasound generator and the ultrasonic transducer step continues for a cavitation time between ten minutes and fifty minutes.

9. The method of claim 2 further comprising a step of providing a commercial food drying case wherein the placing the media's food upon at least a first drying tray step disposes the media's food over a plurality of trays within said case, and wherein the food drying step occurs within said case.

10. The method of claim 9 wherein the providing an ultrasound generator step incorporates a plurality of timer switches operatively incorporated within the ultrasound generator, and further comprising steps of setting, performing, and automatically terminating performance of the soaking step, and successively automatically performing and automatically terminating the ultrasonic cavitation steps.
